(19) United States
(12) Patent Application Publication
(10) Pub. No.: US 2006/0102826 A1
(43) Pub. Date: May 18, 2006

(54) Optical pickup device

(75) Inventor: Makoto Horiyama, Nara-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/270,781

(22) Filed: Nov. 8, 2005

(30) Foreign Application Priority Data
Nov. 12, 2004 (JP) 329508/2004

(51) Int. Cl. G02B 27/40; G02B 27/64

(52) U.S. Cl. 250/201.5

(57) ABSTRACT

An optical pickup device includes: a separation section for separating a light beam into (i) a first light beam, which includes an optical axis of the light beam, and (ii) a second light beam, which surrounds a curved side of the first light beam; and a second light receiving section for receiving the light beam. The second light receiving section includes (I) main light receiving regions, which are provided with a division line therebetween so as to be adjacent to each other and (II) auxiliary light receiving regions, which receive a portion of the light beam which protrudes from each of the main light receiving regions. Each of the auxiliary light receiving regions is positioned in a direction orthogonal to a drawing direction of the division line so as to be adjacent to the main light receiving region. The auxiliary light receiving region is shorter than the main light receiving region in the drawing direction of the division line.

This Nonprovisional application claims priority under 35 U.S.C. § 119(a) on Patent Application No. 329508/2004 filed in Japan on Nov. 12, 2004, the entire contents of which are hereby incorporated by reference.

### FIELD OF THE INVENTION

The present invention relates to an optical pickup device mounted in an optical disk apparatus for optically recording or reproducing information with respect to an information storage medium such as an optical disk. More particularly, the present invention relates to an optical pickup device capable of performing accurate recording/reproducing operation with respect to an optical disk having a plurality of recording/reproducing layers.

### BACKGROUND OF THE INVENTION

In recent years, there has been the increasing use of optical disks in various fields such as audiovisual apparatuses, videos, and computers. This is because the optical disks are capable of recording a large quantity of information signals at high density. Recently, there has been proposed an optical storage medium or the like that meets storage demands (i.e., to increase storage capacity). Such an optical storage medium can be realized by (i) providing a plurality of recording layers, (ii) by causing a laser beam to have a short wavelength, or (iii) increasing a numerical aperture (NA) of an objective lens.

In case of using the storage medium wherein the recording layers are provided at small intervals, reflected light from one of the recording layers being accessed by a light beam is affected by reflected light from an adjacent one of the recording layers. In this case, a focus error signal for focus adjustment of the light beam is similarly affected, so that accurate focus adjustment cannot be carried out.

As illustrated in FIG. 11, an optical pickup device has been proposed as an optical device that solves the foregoing problems (e.g., see Japanese Patent Publication No. 3372413 (Tokkyo 3372413; published on Feb. 4, 2003: Corresponding to U.S. Pat. No. 5,881,035)) (Patent Document 1).

As illustrated in FIG. 11, the optical pickup device disclosed in Patent Document 1 is arranged such that reflected light reflected from an optical disk 904 is diffracted by a hologram element 913, and then is projected on a photodetector 912. As illustrated in FIG. 12, the hologram element 913 is divided into three division regions 913a, 913b, and 913c, by a division line 913g and a division line 913h. The division line 913g extends in a radial direction of the optical disk 904, and the division line 913h starts from the midpoint of the division line 913g and extends in a track direction, i.e., in a direction orthogonal to the radial direction of the optical disk 904.

Further, as illustrated in FIG. 12, the photodetector 912 has four rectangular light receiving regions 912a through 912d aligned in the track direction. The light receiving regions 912a and 912b (focusing-use main light receiving regions) provided in the center are divided by a division line 912y, which is directed in the radial direction. On the other hand, the light receiving region 912c (tracking-use light receiving region) is provided on a side of the light receiving region 912a opposite to the division line 912y with a predetermined interval in the track direction, while the light receiving region 912d (tracking-use light receiving region) is provided on a side of the light receiving region 912b opposite to the division line 912y with a predetermined interval in the radial direction. Note that, in addition to the four light receiving regions 912a through 912d, focusing-use auxiliary light receiving regions 912e and 912f are provided between the light receiving regions 912a and 912c and between the light receiving regions 912b and 912d, respectively.

Further, as illustrated in FIG. 12, the hologram element 913 is divided by the division lines 913g and 913h. As illustrated in FIG. 12, diffracted light diffracted by the hologram element 913 is projected as light beams P91, P92, and P93 on the photodetector 912.

That is, as illustrated in FIG. 13(a), the light beam P91 is projected on the focusing-use light receiving regions 912a and 912b of the photodetector 912. Further, as illustrated in FIG. 13(b), the light beam P91 is projected in its semicircular shape on the focusing-use light receiving region 912b, when the distance between an objective lens 903 and the optical disk 904 is increased. Furthermore, as illustrated in FIG. 13(c), the light beam P91 is projected on a region including the focusing-use light receiving region 912b and the focusing-use auxiliary light receiving region 912f, when the distance between the objective lens 903 and the optical disk 904 is further increased.

On the other hand, as illustrated in FIG. 13(d), the light beam P91 is projected in its semicircular shape on the focusing-use light receiving region 912a, in the case where the distance between the objective lens 903 and the optical disk 904 is reduced. Furthermore, as illustrated in FIG. 13(e), the light beam P91 is projected on a region including the focusing-use light receiving region 912a and the focusing-use auxiliary light receiving region 912e, when the distance between the objective lens 903 and the optical disk 904 is further reduced. Further, as illustrated in FIG. 14, the optical pickup device obtains an FES (focus error signal) by using the focusing-use auxiliary light receiving regions. Therefore, an offset is unlikely to occur in the optical pickup device.

Note that, as illustrated in FIG. 12, the focusing-use light receiving regions 912a and 912b are positioned so that the light beam P91 is projected on the division line 912y. Further, the tracking-use light receiving region 912c is so positioned as to be irradiated with the light beam P93, and the tracking-use light receiving region 912d is so positioned as to be irradiated with the light beam P92.

When output signals from the light receiving regions 912a, 912b, 912c, 912d, 912e, and 912f are given as S1a, S1b, S1c, S1d, S1e, and S1f, respectively, the FES can be obtained by calculating the following equation: FES=(S1a+S1f)−(S1b+S1e). This reshapes an FES curve to be suitable for a multilayer recording medium.

Further, a solid line in FIG. 14 indicates an FES curve (FES=(S1a+S1f)−(S1b+S1e)). Note that, in FIG. 14, the FES curve obtained by calculating FES=(S1a+S1f)−(S1b+S1e) is referred to as an FES curve 1 (indicated by the solid line in FIG. 14). Further, a dotted line in FIG. 14 indicates an FES curve (FES=S1a−S1b). Note that, in FIG. 14, the FES curve obtained by calculating FES=S1a−S1b is referred to as an FES curve 2 (indicated by the dotted line in FIG. 14).

Further, the FES curve 2 is obtained when the focusing-use auxiliary light receiving regions 912e and 912f are not provided. A comparison between the FES curve 1 and the FES curve 2 shows that, whereas the FES curve 2 slowly converges to 0 in a region where a pull-in range goes outside a range of −d1 to +d1, the FES curve 1 quickly converges to 0 in the same region.

Thus, in case of playing the optical disk 904 wherein two layers are provided at an interlayer distance of d2 therebetween, the FES curve 1 becomes two independent FES curves (a dual-layer FES curve) (illustrated in FIG. 15) whose FES offsets are sufficiently small. Therefore, in the arrangement wherein the FES curve 1 is calculated, a normal focus servo can be carried out.

On the other hand, a BD (blu-ray disc) is a type of optical disk specification that allows for high storage capacity. The high storage capacity is realized by (i) causing a laser beam to have a short wavelength, and (ii) increasing a numerical aperture NA of an objective lens. Specifically, the high storage capacity is realized by using (i) an objective lens having a NA of 0.85 and (ii) a laser beam having a wavelength of 405 nm.

As the NA of the objective lens is increased, such an optical disk with high capacity becomes more susceptible to a spherical aberration.

The spherical aberration can be effectively suppressed by reducing a dimensional tolerance of a thickness t of a disk substrate.

However, since an error in the thickness t depends on a manufacturing process of the optical disk, there is such a problem that it is very difficult to improve the dimensional accuracy of the thickness t. Further, the improvement in the dimensional accuracy has a drawback of increasing the cost of manufacturing the optical disk. Therefore, the optical pickup device is required to have a function of correcting the spherical aberration caused when the optical disk is played.

The function of correcting the spherical aberration is usually achieved by mechanically moving a lens such as a beam expander. In order to accurately and quickly correct the spherical aberration, it is necessary to detect a spherical aberration error signal serving as a reference for correcting the spherical aberration.

In order to solve the foregoing problems, Japanese Unexamined Patent Publication No. 157771/2002 (Tokukai 2002-157771; published on May 31, 2002: Corresponding to U.S. Patent Specification No. 2002/0057359) (Patent Document 2) discloses an aberration detection method including the steps of: separating return light into two light beams by using a semi-ring hologram element, as indicated by a hologram region 932b of FIG. 13; and detecting a spherical aberration error signal in accordance with focus positions of the two light beams.

Further, Japanese Unexamined Patent Publication No. 250250/2001 (Tokukai 2001-250250; published on Sep. 14, 2001) (Patent Document 3) discloses a method for inexpensively canceling an offset caused by an objective lens shift or a disk tilt, without reducing efficiency in the use of light.

However, the optical disk whose capacity is increased by (i) causing the laser beam to have the short wavelength, or (ii) increasing the NA of the objective lens, is not free from a problem of the spherical aberration. In addition, the optical pickup device disclosed in Patent Document 1 cannot detect the spherical aberration from a shape of the hologram element. Therefore, the optical pickup device of Patent Document 1 cannot accommodate to the optical device with high capacity.

Further, an aberration detection device disclosed in Patent Document 2 has the hologram element that is divided differently from that of Patent Document 1, so that the light beam on the photodetector takes a shape as illustrated in FIG. 18. Note that FIG. 18 illustrates a case where the focusing-use main light receiving regions and the focusing-use auxiliary light receiving regions, all of which are described in Patent Document 1, are of the same length in the track direction.

For this reason, as illustrated in FIG. 17, offsets in a focus error signal of the aberration detection device occur between −d2 and −d1 and between +d1 and +d2, respectively, on a horizontal axis representing a defocus amount.

As illustrated in FIGS. 18(a) and (c), when the photodetector is irradiated with a semi-ring light beam from the hologram element included in the aberration detection device, the focusing-use main light receiving regions are not irradiated with the light beam. In contrast, the focusing-use auxiliary light receiving regions are only partially irradiated with the light beam. Therefore, as described above, the offsets in the FES of the aberration detection device occur between −d2 and −d1 and between +d1 and +d2, respectively, on the horizontal axis representing the defocus amount.

Further, a change in the shape of the light beam will be described with reference to FIG. 18. The light beam diffracted by the hologram element capable of detecting the spherical aberration is hardly incident on the focusing-use main light receiving regions, as described above, but is incident on the focusing-use auxiliary light receiving regions.

Here, the FES can be expressed in the following equation:

$$\begin{matrix}FES = ( Sa + Sf ) - ( Sb + Se ) \\ = Δ S \\ = Δ d2\end{matrix}$$

where ΔS is an increase in an irradiated portion of the focusing-use auxiliary light receiving regions. Therefore, the FES is disturbed.

Thus, as illustrated in FIG. 17, the offsets occur on the FES curve because the light beam is received by the focusing-use auxiliary light receiving regions. Therefore, a proper FES curve cannot be obtained.

Furthermore, an FES offset of Δd2 occurs in the FES of the aberration detection device in case of playing the dual-layer disk wherein the two layers are provided at the interlayer distance of d2 therebetween. Therefore, a proper focused state cannot be obtained.

### SUMMARY OF THE INVENTION

The present invention has been made in view of the foregoing problems. The present invention has as an object to provide an optical pickup device that is free from influence of reflected light from a non-recording layer, and that is capable of correcting a spherical aberration, and that carries out good focus adjustment, even when carrying out recording/reproducing with respect to a multilayer optical disk.

In order to attain the foregoing object, an optical pickup device according to the present invention includes a separation section for separating a light beam, which is reflected from a storage medium and then passes through converging means, into (i) a first light beam, which includes an optical axis of the light beam, and (ii) a second light beam, which surrounds a curved side of the first light beam; and a second light receiving section for receiving the second light beam, the second light receiving section including (I) at least two main light receiving regions, which are provided with a division line therebetween so as to be adjacent to each other, and (II) one or more auxiliary light receiving regions, which receive a portion of the second light beam which portion protrudes from each of the main light receiving regions, each of the auxiliary light receiving regions being positioned in a direction orthogonal to a drawing direction of the division line so as to be adjacent to the main light receiving region, the auxiliary light receiving region being shorter than the main light receiving region in the drawing direction of the division line.

When the light beam reflected from the storage medium passes, for example, through the converging means including an objective lens, a spherical aberration occurs in the light beam. In order to solve this problem, the light beam is separated into the first light beam, which includes the optical axis of the light beam, and the second light beam, which surrounds the curved side of the light beam P1, and the first and second light beams are received by different light receiving sections, respectively. This makes it possible to compensate an effect of the spherical aberration. Further, use of the main light receiving regions and the auxiliary light receiving regions makes it possible to prevent an effect of return light from a non-recording layer (a layer that does not record/reproduce information) and to obtain a focus error signal, for example, even in case of recording/reproducing information with respect to a multilayer storage medium.

However, the return light from the non-recording layer is projected on a larger area of each of the light receiving sections than return light from a recording layer (a layer that records/reproduces information). Moreover, depending on a focused state of the return light from the recording layer, there are some cases where, although the return light from the non-recording layer is not projected on the main light receiving regions, the return light from the non-recording layer is projected only on the auxiliary light receiving regions that detect return light protruding from the main light receiving regions. In this case, an offset occurs, so that accurate focus control cannot be carried out.

In order to solve this problem, according to the foregoing arrangement, the auxiliary light receiving regions are made shorter than the main light receiving regions in the drawing direction of the division line. This makes it possible to prevent such a problem that, although the return light from the non-recording layer is not projected on the main light receiving regions, the return light from the non-recording layer is projected only on the auxiliary light receiving regions. Therefore, even when recording/reproducing operation is carried out with respect to the multilayer optical disk, it is possible to minimize an effect of reflected light from the non-recording layer and to correct the spherical aberration. This makes it possible to properly carry out focus adjustment.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is an explanatory diagram illustrating (i) a photodetector of a first embodiment according to the present invention and (ii) its light receiving state.

FIG. 2 is a schematic diagram illustrating an optical system of an optical pickup device according to the present invention.

FIG. 3 is an explanatory diagram illustrating a hologram pattern of a first polarizing hologram element for use in the optical pickup device according to the present invention.

FIG. 4 is an explanatory diagram illustrating a hologram pattern of a second polarizing hologram element for use in the optical pickup device according to the present invention.

FIGS. 5A and 5B are explanatory diagrams illustrating light receiving section patterns of the photodetector for use in the optical pickup device of the first embodiment according to the present invention.

FIG. 6 is an explanatory diagram illustrating FES curves of the first embodiment according to the present invention.

FIG. 7 is an explanatory diagram illustrating (i) a photodetector of a second embodiment according to the present invention and (ii) its light receiving state.

FIG. 8 is an explanatory diagram illustrating (i) a photodetector of a third embodiment according to the present invention and (ii) its light receiving state.

FIGS. 9A and 9B are explanatory diagrams illustrating light receiving section patterns of a photodetector for use in an optical pickup device of a fourth embodiment according to the present invention.

FIG. 10 is an explanatory diagram illustrating (i) the photodetector of the fourth embodiment according to the present invention and (ii) its light receiving state.

FIG. 11 is a schematic diagram illustrating an optical system of a conventional optical pickup device.

FIG. 12 is an explanatory diagram illustrating shape and configuration of a hologram element and a photodetector of the conventional optical pickup device.

FIG. 13 is an explanatory diagram illustrating (i) a shape of the photodetector of the conventional optical pickup device and (ii) a light receiving state of the photodetector.

FIG. 14 is an explanatory diagram illustrating FES curves of the conventional optical pickup device.

FIG. 15 is an explanatory diagram illustrating an FES curve of a dual-layer disk in the conventional optical pickup device.

FIG. 16 is an explanatory diagram illustrating a shape of a hologram element, which detects a spherical aberration, of the conventional optical pickup device.

FIG. 17 is an explanatory diagram illustrating an FES curve obtained when the hologram element capable of correcting the spherical aberration is used in the conventional optical pickup device.

FIG. 18 is a diagram illustrating (i) a shape of the photodetector of the conventional optical pickup device and (ii) a light receiving state of the photodetector, the light receiving state being obtained when the hologram element capable of correcting the spherical aberration is used in the conventional optical pickup device.

### DESCRIPTION OF THE EMBODIMENTS

### First Embodiment

One embodiment of the present invention will be described below with reference to the drawings.

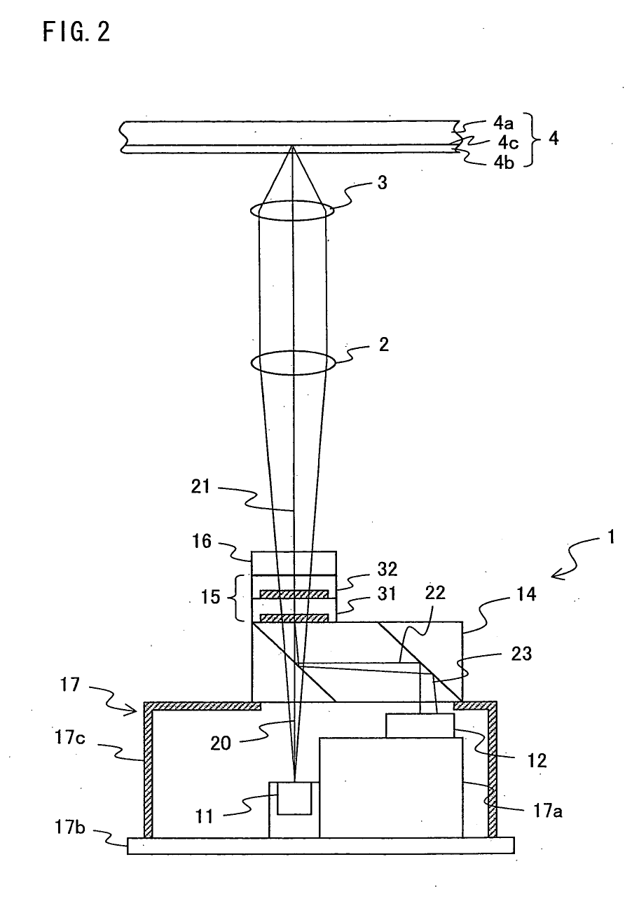

As illustrated in FIG. 2, an optical pickup device according to the present invention includes an optical integrated unit 1, a collimator lens 2, and an objective lens (converging means) 3. Further, light emitted from the optical integrated unit 1 passes through the collimator lens 2 and the objective lens 3, and then is converged and reflected on an optical disk 4. Moreover, the reflected light passes again through the collimator lens 2 and the objective lens 3, and is converged on a photodetector 12 (described later) in the optical integrated unit 1.

The optical pickup device according to the present embodiment is arranged such that: the optical integrated unit 1 includes, as a light source, a laser source that projects a light beam having a short wavelength of approximately 405 nm, and the objective lens 3 has a high numerical aperture (NA) of approximately 0.85. This allows for recording/reproducing operation at high density. When the light source having the short wavelength and the objective lens having the high NA are adopted, an error in a thickness of a cover layer 4b of the optical disk 4 causes a great spherical aberration. In order to correct the spherical aberration caused by the error in the thickness of the cover layer 4b, the collimator lens 2 is moved in an optical axis direction by using a collimator lens driving mechanism (not shown). Alternatively, an interval between two lens groups are adjusted by using a beam expander driving mechanism (not shown), the two lens groups being included in a beam expander (not shown) disposed between the collimator lens 2 and the objective lens 3.

Respective arrangements of the optical pickup device and the optical disk 4 will be described below in detail.

The optical integrated unit 1 includes a semiconductor laser source 11, the photodetector 12, a polarizing beam splitter 14, a polarizing/diffracting element 15, a quarter-wavelength plate 16, and a package 17.

The semiconductor laser source 11 serves as a light source for emitting a laser (hereinafter referred to as “light beam”) to be projected on the optical disk 4. Further, the light beam only needs to have a wavelength A, for example, of 405 nm.

The photodetector 12 receives the light beam reflected by a reflective mirror surface of the polarizing beam splitter 14 described later.

The polarizing beam splitter 14 includes a polarizing beam splitter surface and the reflective mirror surface. The polarizing beam splitter surface (hereinafter referred to as “PBS surface”) transmits the light beam emitted from the semiconductor laser source 11. On the other hand, the PBS surface reflects an S-polarized light beam diffracted by a first polarizing hologram element 31 described later. The reflective mirror surface reflects the S-polarized light beam from the PBS surface, and the S-polarized light beam thus reflected is incident on the photodetector 12.

The polarizing/diffracting element 15 includes the first polarizing hologram element 31 and a second polarizing hologram element (separation means) 32. The first polarizing hologram element 31 diffracts a P-polarized light beam and transmits the S-polarized light beam. Note that a hologram pattern formed on the first polarizing hologram element 31 will be described later. The second polarizing hologram element 32 diffracts the S-polarized light beam and transmits the P-polarized light beam. Note that a hologram pattern of the second polarizing hologram element 32 will be described later.

The quarter-wavelength plate 16 converts a linearly-polarized light beam of the P-polarized light beam into a circularly-polarized light beam. Further, the quarter-wavelength plate 16 also converts the circularly-polarized light beam into a linearly-polarized light beam of the S-polarized light beam.

The package 17 includes a stem 17a, a base 17b, and a cap 17c. The stem 17a is provided with the semiconductor laser source 11 and the photodetector 12. The base 17b serves as a base for the stem 17a. The cap 17c is an outer frame for covering the stem 17a. The cap 17c is provided with a window for transmitting light.

Further, the polarizing beam splitter 14 is designed to be sufficiently larger than an area of the window. The polarizing beam splitter 14 is adhered onto the cap 17c so as to cover the window. This causes the package 17 to be sealed. As a result, the semiconductor laser source 11 and the photodetector 12 are not exposed to the air, so that a characteristic deterioration is unlikely to occur.

The collimator lens 2 causes the circularly-polarized light beam from the quarter-wavelength plate 16 to be parallel to the optical axis direction.

The objective lens 3 converges, on the optical disk 4, the light beam caused by the collimator lens 2 to be parallel to the optical axis direction. Further, the objective lens 3 is driven in a focus direction and in a tracking direction by an objective lens driving mechanism (not shown). Furthermore, even when the optical disk 4 is waggled or decentered, the objective lens 3 causes its converging spot to follow a predetermined position on a recording layer 4c.

The optical disk 4 includes a substrate 4a, the cover layer 4b which transmits the light beam, and the recording layer 4c which is interposed between the substrate 4a and the cover layer 4b.

An optical path in the optical pickup device according to the present embodiment will be described below.

The light beam emitted from the semiconductor laser source 11 passes through the PBS surface, and then is incident on the first polarizing hologram element 31. Since the light beam is the linearly-polarized light beam of the P-polarized light beam, the first polarizing hologram element 31 diffracts the light beam. Further, the fist polarizing hologram element 31 is provided with a hologram pattern for generating three light beams for detecting a tracking error signal (TES). That is, the first polarizing hologram element 31 generates the three light beams from the light beam emitted from the semiconductor laser source 11. In the following, the optical path of one of the three light beams is described. However, the remaining two light beams pass through the same optical path. That is, since all the three light beams are incident on the photodetector 12 through the same optical path, the three light beams are described simply as the light beam for the sake of convenience in description. Further, examples of a method for detecting the TES by using the three light beams include a three-beam method, a differential push-pull (DPP) method, and a phase shift DPP method.

The light beam diffracted by the first polarizing hologram element 31 is incident on the second polarizing hologram element 32.

Since the diffracted light beam is the linearly-polarized light beam of the P-polarized light beam, the second polarizing hologram element 32 transmits the diffracted light beam. The diffracted light beam is incident on the quarter-wavelength plate 16.

The quarter-wavelength plate 16 converts the diffracted light beam, which is the linearly-polarized light beam of the P-polarized light beam, into the circularly-polarized light beam. The light beam converted into the circularly-polarized light beam by the quarter-wavelength plate 16 is incident on the collimator lens 2.

The collimator lens 2 causes the light beam converted into the circularly-polarized light beam to be parallel to the optical axis direction. The parallel light beam is incident on the objective lens 3.

The objective lens 3 converges the parallel light beam on the recording layer 4c of the optical disk 4. The light beam converged on the recording layer 4c is reflected on the recording layer 4c.

The reflected light beam is incident on the quarter-wavelength plate 16 through the objective lens 3 and the collimator lens 2.

The quarter-wavelength plate 16 converts the light beam into the linearly-polarized light beam of the S-polarized light beam. The light beam converted into the S-polarized light beam is incident on the second polarizing hologram element 32.

The second polarizing hologram element 32 diffracts the light beam converted into the S-polarized light beam. The diffracted light beam is incident on the first polarizing hologram element 31.

The first polarizing hologram element 31 transmits the diffracted light beam. The diffracted light beam is reflected by the PBS surface and the reflective mirror surface. Further, the diffracted light beam is separated into a zeroth-order diffracted light beam (non-diffracted light beam) 22 and a first-order diffracted light beam (diffracted light beam) 23, and the two diffracted light beams are incident on the photodetector 12.

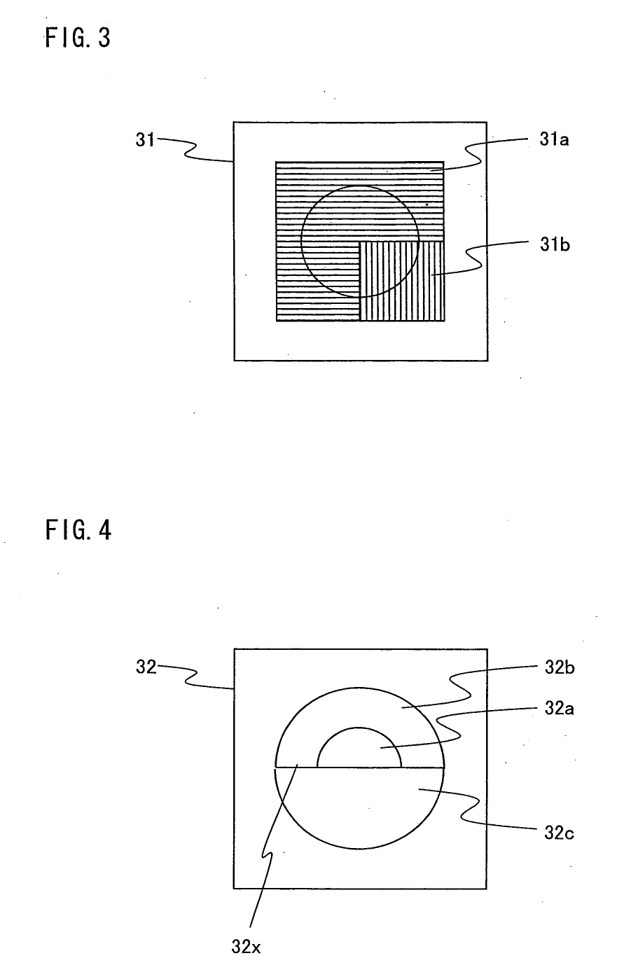

In the following, the hologram pattern formed on the first polarizing hologram element 31 will be described in detail with reference to FIG. 3.

As described above, the first polarizing hologram element 31 is provided with the hologram pattern for generating the three light beams for detecting the TES. For this reason, a lattice pitch of the first polarizing hologram element 31 is designed so that the three beams are sufficiently separated on the photodetector 12. That is, for example, the first polarizing hologram element 31 is designed so that, when a lattice pitch is approximately 11 μm and a distance between the semiconductor laser source 11 and the first polarizing hologram element 31 is approximately 5 mm in an optical path length in the air, an interval between a first light beam and a second light beam on the photodetector 12 is approximately 150 μm and an interval between the first light beam and the second light beam on the optical disk 4 is approximately 16 μm.

Further, the hologram pattern of the first polarizing hologram element 31 may take the form of a regular linear lattice for detecting the TES in accordance with the three-beam method or the DPP method. However, the following explains a case where the phase shift DPP method disclosed in Patent Document 3 is adopted. In this case, as illustrated in FIG. 3, the hologram pattern of the first polarizing hologram element 31 includes a region 31a and a region 31b. Respective periodic structures of the region 31a and the region 31b are 180 degrees out of phase. Such periodic structures cause push-pull signal amplitude of the second light beam to be almost 0. This makes it possible to cancel an offset caused by an objective lens shift or a disk tilt. The more accurately the light beam, which is projected on the first polarizing hologram element 31, is positioned with respect to the region 31a and the region 31b, the better offset cancellation performance becomes. Further, the light beam having a larger effective diameter is less influenced by displacement from the region 31a and the region 31b due to a change over time or a change in temperature.

Further, the hologram pattern formed on the second polarizing hologram element 32 will be described in detail with reference to FIG. 4.

As illustrated in FIG. 4, the second polarizing hologram element 32 includes as the hologram pattern a region (first region) 32a, a region (second region) 32b, and a region (third region) 32c.

The second polarizing hologram element 32 has a circular region thereon, and the circular region is divided into a first semicircular region and a second semicircular region by a division line 32x, which extends in a radial direction of the optical dick 4. The region 32c is this first semicircular region. Further, the region 32a is an inner circumference region obtained by further dividing the second semicircular region by an arc division line, and the region 32b is an outer circumference region of the second semicircular region. The region 32a has a semicircular shape, and the region 32b has an arc shape. Moreover, the photodetector 12 detects a spherical aberration error signal by using at least one of (i) a positive first-order diffracted light beam from the region 32a and (ii) a negative first-order diffracted light beam from the region 32a, and at least one of (iii) a positive first-order diffracted light beam from the region 32b and (iv) a negative first-order diffracted light beam from the region 32b. The light beam is projected on the second polarizing hologram element 32 so that an optical axis of the light beam is matched with the center of the region 32a. That is, the optical axis of the light beam is projected on the division line 32x.

Specifically, at least one of (i) the positive first-order diffracted light beams from the region 32a and (ii) the negative first-order diffracted light beams from the region 32a, and at least one of (iii) the positive first-order diffracted light beam from the region 32b and (iv) the negative first-order diffracted light beam from the region 32b, is projected on main light receiving regions 12i through 12n, so that the spherical aberration error signal is detected. In other words, the spherical aberration error signal can be obtained by detecting respective output signals of (I) the positive (or negative) first-order diffracted light beam from the region 32a and (II) the positive (or negative) first-order diffracted light beam from the region 32b. Further, the photodetector 12 detects a focus error signal in accordance with a knife-edge method. The detection is carried out by using (1) at least one of the positive and negative first-order diffracted light beams from the region 32a, (2) at least one of the positive and negative first-order diffracted light beams from the region 32b, and (3) at least one of positive and negative first-order diffracted light beams from the region 32c. Note that the following description assumes that the positive first-order diffracted light beam from the region 32a is a light beam P1 (first light beam), that the positive first-order diffracted light beam from the region 32c is a light beam P2, and that the positive first-order diffracted light beam from the region 32b is a light beam P3 (second light beam). The light beam P1 is defined as an inner light component of the light beam projected on the second polarizing hologram element 32. The light beam P1 includes the optical axis of the light beam projected on the second polarizing hologram element 32. The light beam P3 is defined as an outer light component of the light beam projected on the second polarizing hologram element 32. The light beam P3 surrounds a curved side of the light beam P1.

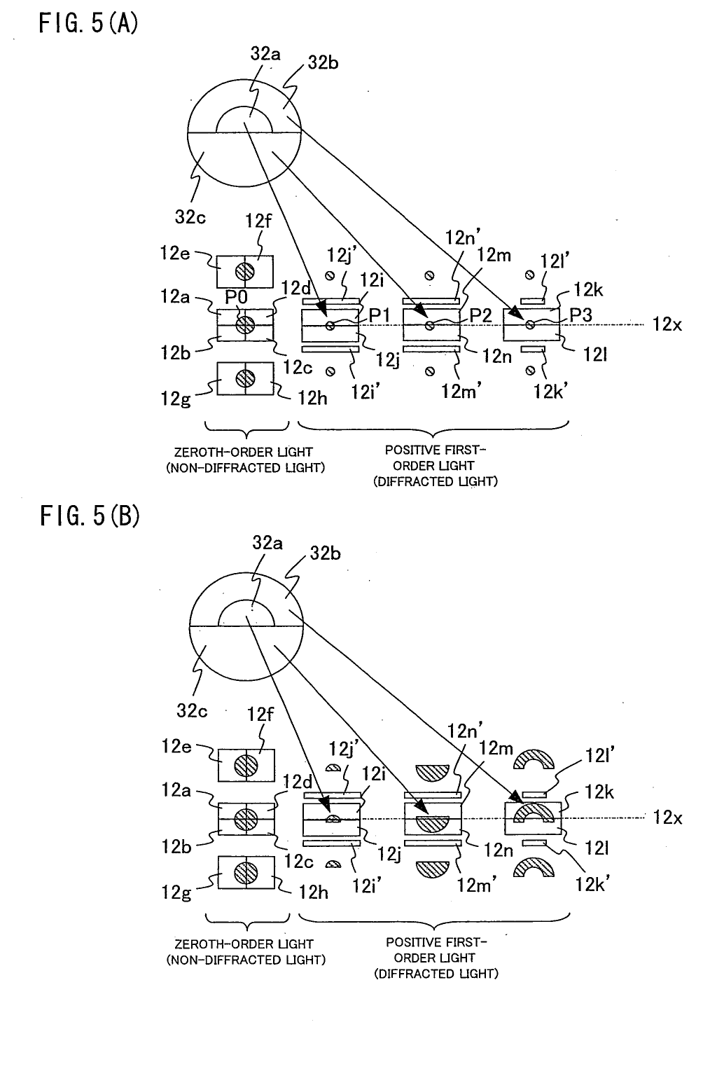

In the following, a relationship between the hologram pattern of the second polarizing hologram element 32 and a light receiving region pattern of the photodetector 12 will be described in detail with reference to FIGS. 5A and 5B.

As illustrated, in FIG. 5A, the photodetector 12 includes fourteen light receiving regions 12a through 12n and six auxiliary light receiving regions 12i′ through 12n′. The auxiliary light receiving regions 12i′ through 12n′ are symmetrical about the division line 12x, which divides the main light receiving regions 12i through 12n. As illustrated in FIG. 5A, the division line 12x extends in the radial direction of the optical disk 4.

Further, FIG. 5A illustrates a state (i.e., a focused state) in which respective optical axis directions of the collimator lens 2 and the objective lens 3 are positioned so that no spherical aberration with respect to the thickness of the cover layer 4b of the optical disk 4 occurs in the light beam converged by the objective lens 3. That is, FIG. 5A is a diagram illustrating the light beams P1, P2, and P3 on the light receiving region 12 in the focused state on the recording layer 4c. Furthermore, FIG. 5A also illustrates a relationship between the three regions 32a through 32c of the second polarizing hologram element 32 and a traveling direction of a first-order diffracted light beam. That is, when the light beam converged by the objective lens 3 is in the focused state with respect to the optical disk 4, the light beam diffracted by the division regions 32a, 32b, and 32c of the second polarizing hologram element 32 is converged as the light beams P1, P3, and P2, respectively, on the division line 12x. For this reason, the main light receiving regions 12i through 12n are disposed so that the light beams P1, P2, and P3 are positioned on the division line 12x.

In actuality, the center of the second polarizing hologram element 32 is positioned so as to correspond to those of the light receiving regions 12a through 12d. However, for the sake of description, the center of the second polarizing hologram element 32 is shifted in a track direction, i.e., in a direction orthogonal to the radial direction of the optical disk 4.

In a forward path optical system (converging optical system), the three light beams diffracted by the first polarizing hologram element 31 are projected on the optical disk 4. Moreover, in a backward path optical system (detecting optical system), the light beams reflected by the optical disk 4 is separated by the second polarizing hologram element 32 into the non-diffracted light beam (zeroth-order diffracted light beam) 22 and the diffracted light beam (positive first-order light beam) 23. The photodetector 12 includes the light receiving regions for receiving that portion of the zeroth-order diffracted light beam 22 which is needed to detect an RF (radio frequency) signal and a servo signal. The photodetector 12 includes the light receiving regions for receiving that portion of the positive first-order diffracted light beam 23 which is needed to detect the RF signal and the servo signal. Specifically, the three light beams incident on the second polarizing hologram element 32 are divided by the second polarizing hologram element 32 into three non-diffracted light beams (zeroth-order diffracted light beams) and nine positive first-order light beams. The non-diffracted light beams (zeroth-order diffracted light beams) are designed to have such a degree of size that TES detection can be carried out in accordance with a push-pull method.

Therefore, the auxiliary light receiving regions 12i′ through 12n′ of the photodetector 12 are provided in a position displaced in the track direction with respect to a focal point of the non-diffracted light beam 22. In FIGS. 5A and 5B, the auxiliary light receiving regions 12i′ through 12n′ of the photodetector 12 are disposed so that the light beams are displaced in the track direction. Further, as illustrated in FIG. 5A, the non-diffracted light beam 22 having a certain degree of size is converged on respective boundary portions of the light receiving regions 12a through 12d. Therefore, positioning of the non-diffracted light beams (zeroth-order diffracted light beams) and the main light-receiving regions 12i through 12n is carried out so that respective outputs of the four light receiving regions are equalized.

Further, FIG. 5B illustrates a relationship between the photodetector 12 and the second polarizing hologram element 32 in a case where a distance between the objective lens 3 and the optical disk 4 when the light beam converged by the objective lens 3 is focused on the optical disk 4 is shorter than the distance between the objective lens 3 and the optical disk 4 when the converged light beam is not focused on the optical disk 4.

In FIG. 5B, the distance between the objective lens 3 and the optical disk 4 when the light beam converged by the objective lens 3 is not focused on the optical disk 4 is longer than the distance between the objective lens 3 and the optical disk 4 when the converged light beam is focused on the optical disk 4. Therefore, the light beams P1, P2, and P3 projected on the auxiliary light receiving regions 12i′ through 12n′ become larger than the light beams P1, P2, and P3 in the focused state as illustrated in FIG. 5A. In FIGS. 5A and 5B, the description assumes that the light beams projected on the auxiliary light receiving regions 12i′ through 12n′ do not protrude from the light receiving regions.

Further, operation for generating various serve signals will be described in detail below with reference to FIGS. 4, 5A, and 5B.

Output signals of the light receiving regions 12a through 12n are represented by Sa through Sn, respectively. Output signals of the auxiliary light receiving regions 12i′ through 12n′ are represented by Si′ through Sn′, respectively.

The RF signal (RF) is detected by using the non-diffracted light beam 22. Note that the RF signal is obtained by calculating the following equation:
RF=Sa+Sb+Sc+Sd

The tracking error signal (TES1) in accordance with the DPP method is detected by comparing respective phases of Sa through Sd.

Further, the tracking error signal (TES2) in accordance with the phase-shift DPP is obtained by calculating the following equation:
TES2={(Sa+Sb)−(Sc+Sd)}−α{(Se−Sf)+(Sg−Sh)}

Note that α in the formula is a coefficient suitable for canceling an offset caused by an objective lens shift or an optical disk tilt.

Furthermore, the spherical aberration error signal (SAES) is detected by using a detection signal from the light beam separated into inner and outer circumferences. Therefore, the SAES is obtained by calculating the following equation:
SAES=(Sk−Sl)−⊕(Sm−Sn)

Note that β in the formula is a coefficient suitable for canceling an offset caused in the SAES.

Further, the focus error signal (FES) is detected in accordance with the knife-edge method. The FES is obtained by calculating the following equation:
FES=(Sk+Sk′)−(Sl+Sl′)

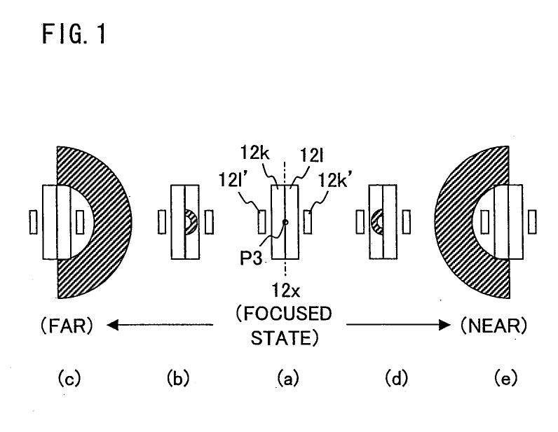

In the following, (i) the light receiving regions 12k, 12k′, 12l′, and 12l′ associated with the focus error signal FES, and (ii) the light beam P3 projected on each of the light receiving regions will be described in detail with reference to FIG. 1.

That portion of the light beam reflected from the optical disk 4 which portion is diffracted by the region 32b of the second polarizing hologram element 32 is incident on the light receiving regions (main light receiving regions) 12k and 12l and the light receiving regions (auxiliary light receiving regions) 12l′ and 12k′.

As illustrated in FIG. 1, the light receiving regions 12k and 12l are adjacent to each other. In other words, the light receiving regions 12k and 12l are obtained by dividing a single light receiving region into two regions by the division line 12x. These light receiving regions 12k and 12l are equivalent to the main light receiving regions. Further, the light receiving regions 12l′ and 12k′ are symmetrical about the division line 12x. The light receiving regions 12l′ and 12k′ are equivalent to the auxiliary light receiving regions. The following description assumes that the light receiving regions 12l′ and 12k′ are the auxiliary light receiving regions 12l′ and 12k′, and that the light receiving region 12k and 12l are the main light receiving regions 12k and 12l.

Further, the main light receiving region 12k and the auxiliary light receiving region 12l′ are positioned on a side of the division line 12x opposite to the main light receiving region 12l and the auxiliary light receiving regions 12k′. In other words, the main light receiving region 12k is disposed between the auxiliary light receiving region 12l′ and the main light receiving region 12l, and the main light receiving region 12l is disposed between the auxiliary light receiving region 12k′ and the main light receiving region 12k.

Here, the light beam is converged on the optical disk 4 by the objective lens 3. That is, as illustrated in FIG. 1(a), in the focused state, the light beam P3 is projected on the division line 12x between the main light receiving regions 12k and 12l adjacent to each other. Further, as illustrated in FIG. 1(b), the light beam P3 having an arc shape (semi-ring shape) is projected only on the main light receiving region 12l, when the light beam converged by the objective lens 3 is not focused on the optical disk 4 and the distance between the objective lens 3 and the optical disk 4 is shorter than a focal length of the objective lens 3. Furthermore, when the distance between the objective lens 3 and the optical disk 4 gradually becomes longer than the focal length of the objective lens 3, the light beam P3 gradually becomes larger so as to protrude from the main light receiving region 12l, and the protruding portion is projected on the auxiliary light receiving region 12k′. In this case, the light beam P3 is projected on both the main light receiving region 12l and the auxiliary light receiving region 12k′. Moreover, as illustrated in FIG. 1(c), the light beam P3 is no longer projected on the main light receiving region 12l and the auxiliary light receiving region 12k′, when the distance between the objective lens 3 and the optical disk 4 becomes much longer than the focal length of the objective lens 3. That is, since the light beam P3 has an arc shape, the light beam P3 is projected on neither the main light receiving region 12l nor the auxiliary light receiving region 12k′.

On the other hand, as shown in FIG. 1(d), the light beam P3 having an arc shape (semi-ring shape) is projected only on the main light receiving region 12k, when the light beam converged by the objective lens 3 is not focused on the optical disk 4 and the distance between the objective lens 3 and the optical disk 4 is shorter than the focal length of the objective lens 3. Furthermore, when the distance between the objective lens 3 and the optical disk 4 gradually becomes shorter than the focal length of the objective lens 3, the light beam 3 gradually becomes larger so as to protrude from the main light receiving region 12k, and the protruding portion is projected on the auxiliary light receiving region 12l′. In this case, the light beam P3 is projected on both the main light receiving region 12k and the auxiliary light receiving region 12l′. In the meanwhile, as illustrated in FIG. 1(e), the light beam P3 is no longer projected on the main light receiving region 12k and the auxiliary light receiving region 12l′, when the distance between the objective lens 3 and the optical disk 4 becomes much shorter than the focal length of the objective lens 3.

In the following, respective shapes of the main light receiving regions 12k and 12l and the auxiliary light receiving regions 12k′ and 12l′ will be described below. The main light receiving regions 12k and 12l and the auxiliary light receiving regions 12k′ and 12l′ are irradiated with the light beam P3, which is diffracted by the region 32b of the second polarizing hologram element 32 of the present embodiment. The light beam P3 surrounds the curved side of the light beam P1, which includes the optical axis of the light beam projected on the second polarizing hologram element 32.

In the present embodiment, as illustrated in FIG. 1, the auxiliary light receiving regions 12k′ and 12l′ are shorter than the main light receiving regions 12k and 12l in a drawing direction of the division line 12x.

Moreover, the light beam P3, which is diffracted by the region 32b of the second polarizing hologram element 32 and which is projected on the main light receiving regions 12k and 12l and the auxiliary light receiving regions 12k′ and 12l′, has a semi-ring shape. For this reason, for example, when the distance between the objective lens 3 and the optical disk 4 becomes longer or shorter than the focal length of the objective lens 3, and the light beam P3 is not projected on the main light receiving region 12l or 12k, the auxiliary light receiving region 12k′ or 12l′ is positioned in a portion that is between the main light receiving region 12l or 12k and the light beam P3 having a semi-ring shape and that is not irradiated with the light beam P3. That is, according to the foregoing arrangement, the light beam is never projected only on the auxiliary light receiving region 12k′ or 12l′. Therefore, it is possible to prevent an offset caused when the light beam P3 is projected only on the auxiliary light receiving region 12k′ or 12l′. The offset prevention will be described below with reference to FES curves.

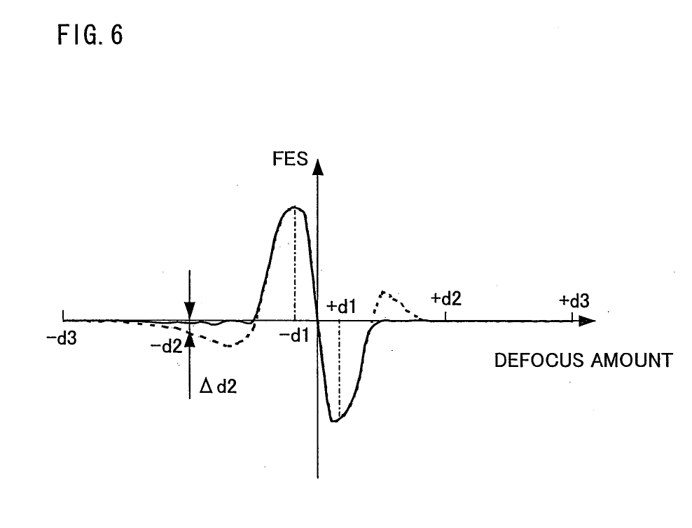

FIG. 6 is a graph showing an FES curve in the present embodiment and an FES curve in a comparative example. A solid line in FIG. 6 indicates an FES curve obtained when the auxiliary light receiving regions 12k′ and 12l′ according to the present embodiment are shorter than the main light receiving regions 12k and 12l in the direction of the division line. For the sake of convenience in description, the FES curve indicated by the solid line in FIG. 6 is given as an FES curve 4. Further, a dotted line in FIG. 6 indicates an FES curve obtained when the main light receiving regions according to the comparative example are of the same length as the auxiliary light receiving regions in the direction of the division line. For the sake of convenience in description, the FES curve indicated by the dotted line in FIG. 6 is given as an FES curve 5.

As illustrated in FIG. 6, a comparison between the FES curve 4 (present embodiment) and the FES curve 5 (comparative example) shows that no offset occurs in the FES curve 4 in an interval between −d2 and −d1 and in an interval between +d1 and +d2, respectively, on a horizontal axis representing a defocus amount. On the other hand, an offset occurs in the FES curve 5 in the same intervals. The FES curve 4 is obtained when the auxiliary light receiving regions 12k′ and 12l′ are shorter than the main light receiving regions 12k and 12l in the direction of the division line. When the light beam P3 having a semi-ring shape is not projected on the main light receiving regions 12k and 12l, the light beam P3 is not projected on the auxiliary light receiving regions 12k′ and 12l′, either. In other words, in the present embodiment, since the auxiliary light receiving regions 12k′ and 12l′ are shorter than the main light receiving regions 12k and 12l in the direction of division line, the light beam P3 is prevented from being projected only on the auxiliary light receiving regions 12k′ and 12l′. This makes it possible to prevent an offset caused when the light beam P3 is projected only on the auxiliary light receiving regions 12k′ and 12l′. Therefore, like in the FES curve 4, no offset occurs in the FES in the interval between +d1 and +d2 and in the interval between −d1 and −d2.

On the other hand, the FES curve 5 is obtained when the main light receiving regions are of the same length as the auxiliary light receiving regions in the direction of the division line. Although the main light receiving regions are not irradiated with the semi-ring light beam, the auxiliary light receiving regions are irradiated with the semi-ring light beam. The irradiated portion appears as an offset in the interval between +d1 and +d2 and in the interval between −d1 and −d2.

Therefore, an offset amount is suppressed in the FES curve 4, and an offset occurs in the FES curve 5.

In this case, an offset amount Δd2 is suppressed. The offset occurs, for example, in case of playing a dual-layer disk wherein two layers are provided at an interlayer distance of d2 therebetween. In this case, as illustrated in FIG. 15, two independent FES curves (a dual-layer FES curve) having sufficiently small FES offsets are obtained. Therefore, a normal focus servo can be carried out.

Therefore, according to this method for the offset prevention, in case of playing a first one of a plurality of recording/reproducing layers of a multilayer disk provided with an auxiliary light receiving region that does not receive reflected light from a second one of the recording/reproducing layers, an FES offset in the first recording/reproducing layer can be corrected by using a signal from the auxiliary light receiving region whose shape has been optimized.

That is, the optical pickup device according to the present invention is arranged such that the auxiliary light receiving region is provided in a portion that does not receive the light beam P3 in its greatly defocused state, so as to optimize a shape of the light beam P3. Thus, in case of playing the first recording/reproducing layer of the multilayer disk, the FES offset in the first recording/reproducing layer can be corrected by using a signal from a non-recording/reproducing layer.

Further, in all the configurations, the main light receiving regions 12k and 12l and the auxiliary light receiving regions 12k′ and 12l′ are shaped (in terms of width, length, etc.) and disposed so that the FES can be decreased to 0 at a desired defocus amount. That is, the FES can be corrected by shaping (in terms of width, length, etc.) and disposing the main light receiving regions 12k and 12l and the auxiliary light receiving regions 12k′ and 12l′ so that, when the main light receiving regions 12k and 12l are not irradiated with the light beam P3, the auxiliary light receiving regions 12k′ and 12l′ are not irradiated, either. This allows for such a setting that FESs of a plurality of recording/reproducing layers in a mutilayer optical disk do not interfere with one another. The setting is carried out in accordance with an interval with which the recording/reproducing layers are provided.

Further, the focus error signal FES may be generated by carrying out the foregoing calculation. The foregoing calculation is carried out by amplifying or attenuating outputs from the auxiliary light receiving regions 12k′ and 12l′ at a fixed ratio with respect to the main light receiving regions 12k and 12l. This increases a degree of freedom of configuration of the auxiliary light receiving regions 12k′ and 12l′.

As described above, the optical pickup device of the foregoing arrangement includes: the second polarizing hologram element 32 for separating a light beam, which is reflected from a storage medium and then passed through converging means including the objective lens 3, into (i) the light beam P1, which includes an optical axis of the light beam, and (ii) the light beam P3, which surrounds a curved side of the first light beam; and a second light receiving section for receiving the light beam P3, the second light-receiving section including (I) at least the two main light receiving regions 12k and 12l, which are provided with the division line 12x therebetween so as to be adjacent to each other, and (II) the auxiliary light receiving regions 12k′ and 12l′, which receives a portion of the light beam P3 which portion protrudes from each of the main light receiving regions 12k and 12l, each of the auxiliary light receiving regions 12k′ and 12l′ being positioned in a direction orthogonal to a drawing direction of the division line 12x so as to be adjacent to the main light receiving region 12k or 12l, and the auxiliary light receiving region 12k′ or 12l being shorter than the main light receiving region 12k or 12l in the drawing direction of the division line 12x.

When an optical disk (storage medium) is played, the light beam reflected from the storage medium causes a spherical aberration in accordance with an error in a thickness of a disk substrate. In order to solve this problem, the light beam is separated into the light beam P1, which includes the optical axis of the light beam, and the light beam P3, which surrounds the curved side of the light beam P1, and the light beams P1 and P3 are received by the different light receiving sections, respectively. This makes it possible to compensate an effect of the spherical aberration. Further, use of the main light receiving regions and the auxiliary light receiving regions makes it possible to prevent an effect of return light from a non-recording layer (a layer that does not record/reproduce information) and to obtain a focus error signal, for example, even in case of recording/reproducing information with respect to a multilayer storage medium.

However, the return light from the non-recording layer is projected on a larger area of each of the light receiving sections than return light from a recording layer (a layer that records/reproduces information). Moreover, depending on a focused state of the return light from the recording layer, there are some cases where, although the return light from the non-recording layer is not projected on the main light receiving regions, the return light from the non-recording layer is projected only on the auxiliary light receiving regions that detect return light protruding from the main light receiving regions. In this case, an offset occurs, so that accurate focus control cannot be carried out.

In order to solve this problem, according to the foregoing arrangement, the auxiliary light receiving regions 12k′ and 12l′ are made shorter than the main light receiving regions 12k and 12l in the drawing direction of the division line 12x. This makes it possible to prevent such a problem that, although the return light from the non-recording layer is not projected on the main light receiving regions 12k and 12l, the return light from the non-recording layer is projected only on the auxiliary light receiving regions 12k′ and 12l′. Therefore, even when recording/reproducing operation is carried out with respect to the multilayer optical disk, it is possible to minimize an effect of reflected light from the non-recording layer and to correct the spherical aberration. This makes it possible to properly carry out focus adjustment.

Furthermore, according to the foregoing arrangement, the auxiliary light receiving regions 12k′ and 12l′ are preferably sized so that, in a state in which the main light receiving regions 12k and 12l are not irradiated with the light beam P3, the auxiliary light receiving regions 12k′ and 12l′ are not irradiated with the light beam P3, either.

According to the foregoing arrangement, the auxiliary light receiving regions 12k′ and 12l′ are preferably sized so that, in a state in which the main light receiving regions 12k and 12l are not irradiated with the light beam P3, the auxiliary light receiving regions 12k′ and 12l′ are not irradiated with the light beam P3, either. Thus, the return light from the non-recording layer is projected on a larger area of each of the light receiving sections than the return light from the recording layer. Therefore, the foregoing arrangement makes it possible to more reliably prevent such a problem that, although the return light from the non-recording layer is not projected on the main light receiving regions 12k and 12l, the return light from the non-recording layer is projected only on the auxiliary light receiving regions 12k′ and 12′.

Further, the optical pickup device of the foregoing arrangement preferably includes a first light receiving section for receiving the light beam P1, the first light receiving section including (i) at least two first main light receiving regions 12i and 12j, which are provided with a first division line therebetween parallel to the division line 12x so as to be adjacent to each other, and (ii) first auxiliary light receiving regions 12i′ and 12j′, which receive a portion of the light beam P1 which portion protrudes from the first main light receiving regions, the auxiliary light receiving regions 12k′ and 12l′ detecting only the light beam P3, and the first auxiliary light receiving regions 12i′ and 12j′ detecting only the light beam P1.

According to the foregoing arrangement, the first auxiliary light receiving regions 12i′ and 12j′ receive only the light beam P1, and the auxiliary light receiving regions 12k′ and 12l′ receive only the light beam P3. This makes it possible to prevent the light beam P1 from entering the auxiliary light receiving regions 12k′ and 12l′ for receiving the light beam P3 and to prevent the light beam P3 from entering the auxiliary light receiving regions 12i′ and 12j′ for receiving the light beam P1 even when the light beams P1 and P3 are in their defocused states. For this reason, no offset occurs in a focus signal. Therefore, accurate focus control can be carried out.

Furthermore, the optical pickup device of the foregoing arrangement preferably includes calculation means for generating a focus error signal by obtaining a difference between a first signal (Sk+Sk′) and a second signal (Sl+Sl′), the first signal (Sk+Sk′) being obtained by adding (i) an output signal from the main light receiving region 12k provided on a first side in the direction orthogonal to the division line 12x and (ii) an output signal from the auxiliary light receiving region 12k′ provided on a second side in the direction orthogonal to the division line 12x opposite to the first side, the second signal (Sl+Sl′) being obtained by adding (I) an output signal from the main light receiving region 12l provided on the second side and (II) an output signal from the auxiliary light receiving region 12l′ provided on the first side.

The foregoing arrangement makes it possible to prevent an offset even when there is stray light from the non-recording layer, and thereby making it possible to carry out accurate focus control.

### Second Embodiment

Another embodiment of the present invention will be described below with reference to the drawings. Note that members having the same functions as those described in the first embodiment are given the same reference numerals, and the descriptions thereof are omitted.

The present embodiment defines a relationship between (i) respective shapes of the main light receiving regions 12i and 12j and the auxiliary light receiving regions 12i′ and 12j′ and (ii) respective shapes of the main light receiving regions 12k and 12l and the auxiliary light receiving regions 12k′ and 12l′. The main light receiving regions 12i and 12j and the auxiliary light receiving regions 12i′ and 12j′ are irradiated with the light beam P1 diffracted by the region 32a of the second polarizing hologram element 32. The light beam P1 includes the optical axis of the light beam projected on the second polarizing hologram element 32. The main light receiving regions 12k and 12l and the auxiliary light receiving regions 12k′ and 12l′ are irradiated with the light beam P3. Specifically, the following description in the present embodiment assumes that the first main light receiving regions 12i and 12j, which receive the light beam P1, are of the same length as the first auxiliary light receiving regions 12i′ and 12j′ in the drawing direction of the division line 12x, and that the auxiliary light receiving regions 12k′ and 12l′ are shorter than the first auxiliary light receiving regions 12i′ and 12j′ in the drawing direction of the division line 12x.

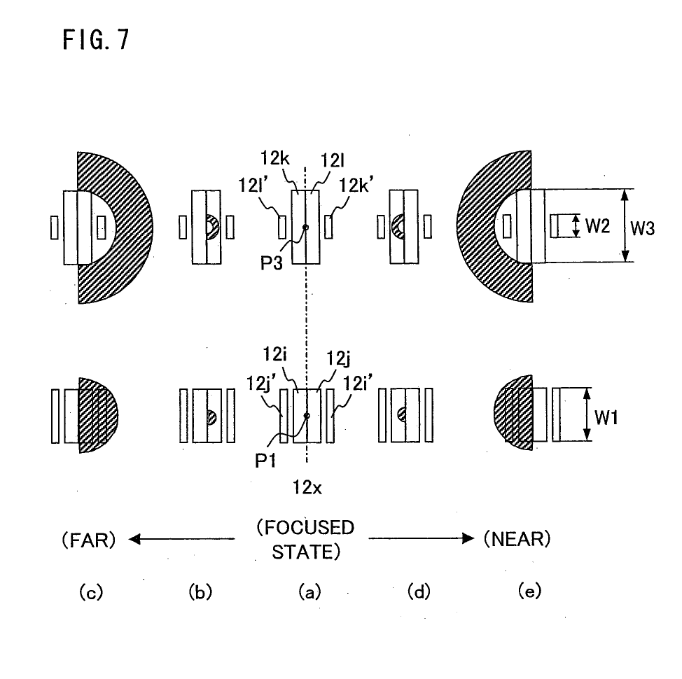

In the present embodiment, the focus error signal FES is detected in accordance with the knife-edge method. The FES is detected by using light diffracted by the regions 32a and 32b of the second polarizing hologram element 32 described above in the first embodiment. As illustrated in FIG. 7(a), in a focused state, the light beams P1 and P3 are converged. The light beam P3 is the same as that described above in the first embodiment.

As illustrated in FIG. 7(a), the light beam P1 is projected on the division line 12x between the first light receiving regions 12i and 12j adjacent to each other, when the light beam is converged on the optical disk 4 by the objective lens 3, i.e., is in its focused state. Further, as illustrated in FIG. 7(b), the light beam P1 having a semicircular shape is projected only on the first main light receiving region 12j, when the light beam converged by the objective lens 3 is not focused on the optical disk 4 and the distance between the objective lens 3 and the optical disk 4 are longer than the focal length of the objective lens 3. Furthermore, as illustrated in FIG. 7(c), the light beam P1 protrudes from the first main light receiving region 12j and the protruding portion is projected on the first auxiliary light receiving region 12i′, when the distance between the objective lens 3 and the optical disk 4 becomes much longer than the focal length of the objective lens 3. In this case, the light beam P1 is projected on both the first main light receiving region 12j and the first auxiliary light receiving region 12i′.

On the other hand, as illustrated in FIG. 7(d), the light beam P1 having a semicircular shape is projected only on the first main light receiving region 12i, when the light beam converged by the objective lens 3 is not focused on the optical disk 4 and the distance between the objective lens 3 and the optical disk 4 is shorter than the focal length of the objective lens 3. Furthermore, as illustrated in FIG. 7(e), the light beam P1 protrudes from the first main light receiving region 12i and the protruding portion is projected on the first auxiliary light receiving region 12j′, when the distance between the objective lens 3 and the optical disk 4 becomes much shorter than the focal length of the objective lens 3. In this case, the light beam P1 is projected on both the first main light receiving region 12i and the first auxiliary light receiving region 12j′.

The first main light receiving regions 12i and 12j are symmetrical about the division line 12x, and the first auxiliary light receiving regions 12i′ and 12j′ are symmetrical about the division line 12x. That is, since the first main light receiving regions 12i and 12j have the same width and length, their respective areas are equal to each other. Further, since the first auxiliary light receiving regions 12i′ and 12j′ have the same width and length, their respective areas are equal to each other.

This will be described below with reference to an FES curve.

An FES curve obtained with respect to the light receiving regions 12i, 12j, 12i′, and 12j′ is given as an FES curve 6. The FES curve 6 more rapidly converges to 0 outside a defocus amount range of −d1 to +d1 than in a case where the auxiliary light receiving regions 12i′ and 12j′ are not provided.

Further, as described in the first embodiment, no offset occurs in the FES obtained from the light receiving regions 12k, 12l, 12k′, and 12l′.

Therefore, the FES in the present embodiment is obtained by calculating the following equation:

$$\begin{matrix}FES = ( Si + Sk + {Si}^{′} + {Sk}^{′} ) - ( Sj + S1 + {Sj}^{′} + {S1}^{′} ) \\ = \{ ( Si + {Si}^{′} ) - ( Sj + {Sj}^{′} ) \} + \{ ( Sk + {Sk}^{′} ) - ( S1 + {S1}^{′} ) \}\end{matrix}$$

In this equation, in addition to the signals Sk, S1, Sk′, and Sl′ respectively obtained from the light receiving regions 12k, 12l, 12k′, and 12l′, signals Si, Sj, Si′, and Sj′ respectively obtained from the light receiving regions 12i, 12j, 12i′, and 12j′ are used.

Thus, no offset occurs in the FES. Therefore, an accurate focus servo can be carried out.

Furthermore, since both the light beam from the region 32a and the light beam from the region 32b are used, an increase in amount of light detected in the light receiving regions is expected. This makes it possible to obtain a good-quality FES with large amplitude.

Further, the length of the first main light receiving regions 12i and 12j, which receive the light beam P1, in the drawing direction of the division line 12x is given as W1. The length of the main light receiving regions 12k and 12l, which receive the light beam P3, in the drawing direction of the division line 12x is given as W3. In this case, the following relation is set in the present embodiment: W1<W3. This is because, since the regions 32a and 32b have different shapes, the light beams on the photodetector 12 have different shapes. When W1 is equal to W3, the light beam P1 in its greatly defocused state cannot be corrected using the first auxiliary light receiving regions 12i′ and 12j′. Thus, an offset occurs in the greatly defocused state.

Furthermore, the length of the auxiliary light receiving regions 12k′ and 12l′, which receive the light beam P3, in the drawing direction of the division line 12x is given as W2. In this case, the following relationship is preferable: W2<W1<W3. W1, W2, and W3 are so sized as not to protrude from the light receiving regions. Also, the following relation is possible: W1=W2=W3. In this case, the photodetector 12 becomes larger as a whole.

As described above, the optical pickup device according to the present invention is preferably arranged such that: the first main light receiving regions are as long as the first auxiliary light receiving regions in the drawing direction of the division line 12x, and the auxiliary light receiving regions are shorter than the first auxiliary light receiving regions in the drawing direction of the division line 12x.

The first light beam includes the optical axis of the light beam reflected from the storage medium, and when the first light beam is projected on the light receiving section, the first light beam is projected, for example, in its semicircular shape. Therefore, even when the light beam is not focused, the first light beam is never projected only on the first auxiliary light receiving regions without being projected on the first main light receiving regions. Further, the light receiving regions having larger light receiving areas can detect a larger quantity of light beams than when the light receiving regions have smaller areas. Therefore, the first light beam can be more accurately detected by using the foregoing arrangement in which the first main light receiving regions are of the same length as the first auxiliary light receiving regions in the drawing direction of the division line. Further, by causing the auxiliary light receiving regions to be shorter than the first auxiliary light receiving regions, it is possible to more reliably prevent such a problem that, although the return light from the non-recording layer is not projected on the main light receiving regions, the return light is projected on the auxiliary light receiving regions.

### Third Embodiment

A further embodiment of the present invention will be described below with reference to the drawing. Note that members having the same functions as those described in the first embodiment are given the same reference numerals, and the descriptions thereof are omitted.

As described in the first embodiment, the second polarizing hologram element 32 is divided into the three regions 32a, 32b, and 32c. The region 32a diffracts the light beam P1. The region 32c diffracts the light beam P2. The region 32b diffracts the light beam P3. The light beam P1 is projected on the first main light receiving regions 12i and 12j and the first auxiliary light receiving regions 12i′ and 12j′. The light beam P2 is projected on second main light receiving regions 12m and 12n and second auxiliary light receiving regions 12m′ and 12n′. The light beam P3 is projected on the main light receiving regions 12k and 12l and the auxiliary light receiving regions 12k′ and 12l′. Described in the present embodiment is an example of obtaining an FES by using all the main light receiving regions 12i, 12j, 12k, 12l, 12m, and 12n and all the auxiliary light receiving regions 12i′, 12j′, 12k′, 12l′, 12m′, and 12n′.

The present embodiment will describe second main light receiving regions 12m and 12n and the second auxiliary light receiving regions 12m′ and 12n′.

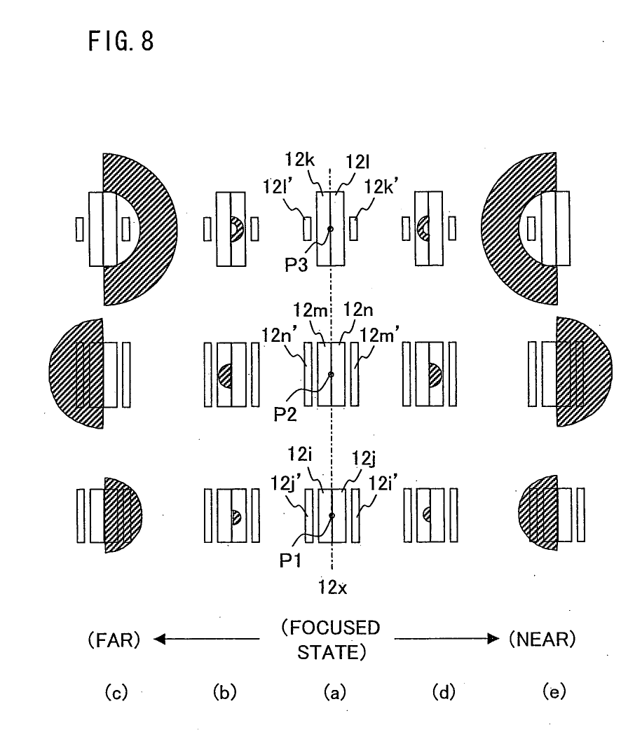

In the present embodiment, the focus error signal FES is detected in accordance with a double knife-edge method. The FES is detected by using light diffracted by the regions 32a and 32b of the second polarizing hologram element 32 described in the second embodiment. As illustrated in FIG. 8(a), in a focused state, the light beams P1, P2, and P3 are converged. The light beams P1 and P3 are the same as those described above in the first embodiment.

Here, the light beam is converged on the optical disk 4 by the objective lens 3. That is, as illustrated in FIG. 8(a), in the focused state, the light beam P2 is projected on the division line 12x between the second main light receiving regions 12m and 12n adjacent to each other. Further, as illustrated in FIG. 8(b), the light beam P2 having a semicircular shape is projected only on the second main light receiving region 12m, when the light beam converged by the objective lens 3 is not focused on the optical disk 4 and the distance between the objective lens 3 and the optical disk 4 is longer than the focal length of the objective lens 3. Furthermore, as illustrated in FIG. 8(c), the light beam P2 protrudes from the second main light receiving region 12m and the protruding portion is projected on the second auxiliary light receiving region 12n′, when the distance between the objective lens 3 and the optical disk 4 becomes much longer than the focal length of the objective lens 3. In this case, the light beam P2 is projected on both the second main light receiving region 12m and the second auxiliary light receiving region 12n′.

On the other hand, as illustrated in FIG. 8(d), the light beam P2 having a semicircular shape is projected only on the second main light receiving region 12n, when the light beam converged by the objective lens 3 is not focused on the optical disk 4 and the distance between the objective lens 3 and the optical disk 4 is shorter than the focal length of the objective lens 3. Furthermore, as illustrated in FIG. 8(e), the light beam P2 protrudes from the second main light receiving region 12n and the protruding portion is projected on the second auxiliary light receiving region 12m′, when the distance between the objective lens 3 and the optical disk 4 becomes much shorter than the focal length of the objective lens 3. In this case, the light beam P2 is projected on both the main light receiving region 12n and the second auxiliary light receiving region 12m′.

The second main light receiving regions 12m and 12n are symmetrical about the division line 12x, and the second auxiliary light receiving regions 12m′ and 12n′ are symmetrical about the division line 12x. That is, since the second main light receiving regions 12m and 12n have the same width and length, their respective areas are equal to each other. Further, since the second auxiliary light receiving regions 12m′ and 12n′ have the same width and length, theirs respective areas are equal to each other.

An FES curve obtained with respect to the light receiving regions 12m, 12m′, 12n, and 12n′ is given as an FES curve 7. The FES curve 7 may quickly converge to 0 outside a defocus amount range of −d1 to +d1, as compared to a case where the second auxiliary light receiving regions 12m′ and 12n′ are not provided.

Further, as described in the second embodiment, no offset occurs in the FESs obtained from the main light receiving regions 12i and 12j and the auxiliary light receiving regions 12i′, 12j′, and the main light receiving regions 12k and 12l and the auxiliary light receiving regions 12k′, 12l′, respectively.

Therefore, the FES in the present embodiment can be obtained by calculating the following equations:

$$\begin{matrix}FES = ( Si + Sk + Sm + {Si}^{′} + {Sk}^{′} + {Sm}^{′} ) - ( Sj + S1 + Sn + {Sj}^{′} + {S1}^{′} + {Sn}^{′} ) \\ = \{ ( Si + {Si}^{′} ) - ( Sj + {Sj}^{′} ) \} + \{ ( Sk + {Sk}^{′} ) - ( S1 + {S1}^{′} ) \} + \{ ( Sm + {Sm}^{′} ) \} - \\ ( Sn + {Sn}^{′} ) \}\end{matrix}$$

In this equation, in addition to the signals Si, Sj, Si′, Sj′, Sk, Sl, Sk′, and Sl′ respectively obtained from the light receiving regions 12i, 12j, 12i′, 12j′, 12k, 12l, 12k′, and 12l′, signals Sm, Sn, Sm′, and Sn respectively obtained from the light receiving regions 12m, 12n, 12m′, and 12n′ are used.

This prevents an offset from occurring in the FES and thereby allows for a more accurate focus servo.

Furthermore, the optical pickup device of the foregoing arrangement is arranged such that: the second polarizing hologram element 32 is a hologram element that separates the light beam by diffracting the light beam, the light beam passing through the converging means, and the hologram element separates the light beam into portions corresponding respectively to at least two regions provided with a straight line therebetween substantially parallel to a diffraction direction of the light beam.

According to the foregoing arrangement, the light beams in all the regions divided by the straight line substantially parallel to the diffraction direction of the hologram element are used. For this reason, an increase in an amount of light detected in the light receiving regions is expected. This makes it possible to obtain a good-quality FES signal with large amplitude. Thus, no focus offset occurs even when there is stray light from a non-recording layer. Therefore, an accurate focus servo can be carried out.

### Fourth Embodiment

A further embodiment of the present invention will be described below with reference to the drawing. Note that members having the same functions as those described in the first embodiment are given the same reference numerals, and the descriptions thereof are omitted.

As described in the first embodiment, the second polarizing hologram element 32 is divided into the three regions 32a, 32b, and 32c. The region 32a diffracts the light beam P1. The region 32c diffracts the light beam P2. The region 32b diffracts the light beam P3. The light beam P1 is projected on the first main light receiving regions 12i and 12j and the first auxiliary light receiving regions 12i′ and 12j′. The light beam P2 is projected on the second main light receiving regions 12m and 12n and the second auxiliary light receiving regions 12m′ and 12n′. The light beam P3 is projected on the main light receiving regions 12k and 12l and the auxiliary light receiving regions 12k′ and 12l′. Described in the present embodiment is an example of detecting an FES by using both positive and negative first-order diffracted light beams with respect to the configuration of the main light receiving regions 12i through 12n and the auxiliary light receiving regions 12i′ through 12n′.

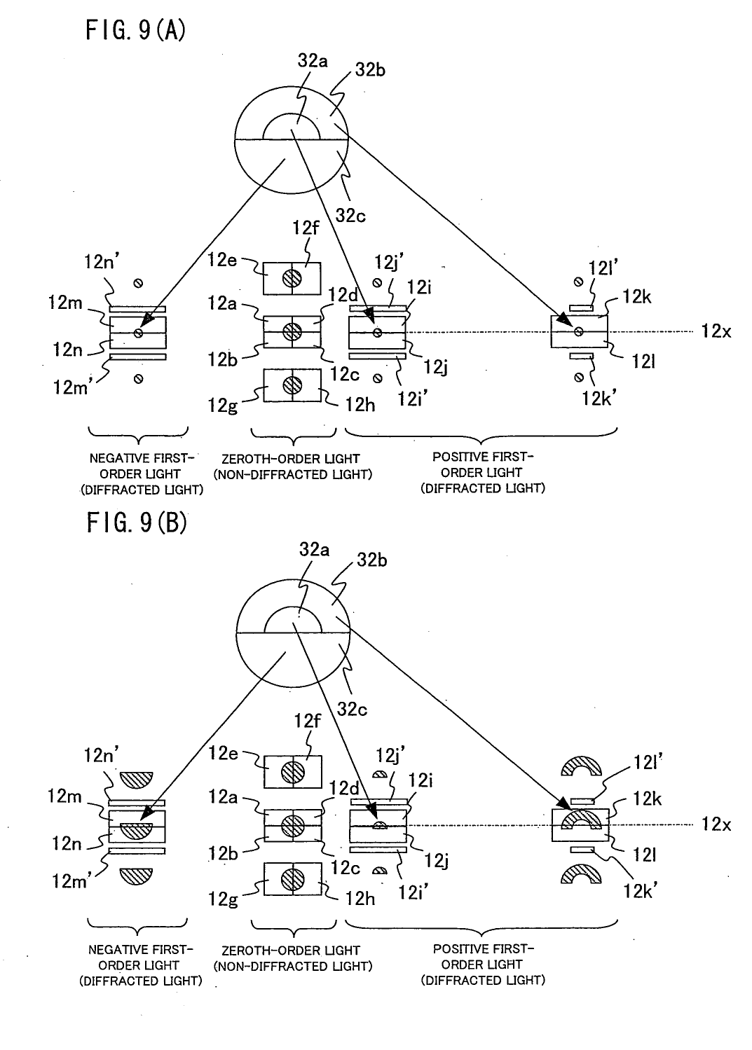

FIGS. 9A and 9B are explanatory diagrams illustrating light receiving section patterns of the photodetector 12 for use in the optical integrated unit 1 of the present invention. The photodetector 12 includes fourteen main light receiving regions 12a through 12n and six auxiliary light receiving regions 12i′ through 12n′. The auxiliary light receiving region 12i′ is positioned farther from the division line 12x than the main light receiving region 12j so as to be adjacent to the main light receiving region 12j. The auxiliary light receiving region 12j′ is positioned farther from the division line 12x than the main light receiving region 12i so as to be adjacent to the main light receiving region 12i. The auxiliary light receiving region 12k′ is positioned farther from the division line 12x than the main light receiving region 12l so as to be adjacent to the main light receiving region 12l. The auxiliary light receiving region 12l′ is positioned farther from the division line 12x than the main light receiving region 12k so as to be adjacent to the main light receiving region 12k. The auxiliary light receiving region 12m′ is positioned farther from the division line 12x than the main light receiving region 12n so as to be adjacent to the main light receiving region 12n. The auxiliary light receiving region 12n′ is positioned farther from the division line 12x than the main light receiving region 12m so as to be adjacent to the main light receiving region 12m.

In the forward path optical system, the three light beams diffracted by the first polarizing hologram element 31 are projected on the optical disk 4. Meanwhile, in the backward path optical system, the light beam reflected by the optical disk 4 is separated by the second polarizing hologram element 32 into the non-diffracted light beam (zeroth-order diffracted light beam) 22 and the diffracted light beam (positive/negative diffracted light beam) 23. The photodetector 12 includes the light receiving regions for receiving that portion of the non-diffracted light beam 22 which is needed to detect an RF signal and a servo signal. The photodetector 12 includes the light receiving regions for receiving that portion of the diffracted light beam 23 which is needed to detect the RF signal and the servo signal. Specifically, the second polarizing hologram element 32 forms twelve light beams in total. The twelve light beams consist of three non-diffracted light beams (zeroth-order diffracted light beams), six positive first-order diffracted light beams, and three negative first-order diffracted light beams. In this case, the hologram pattern is brazed, so that an unnecessary diffracted light beam is not generated.

In the present embodiment, the focus error signal FES is detected in accordance with the double knife-edge method. The FES is obtained by calculating the following equation:
FES=(Si+Sk+Sm+Si′+Sk′+Sm′)−(Sj+Sl+Sn+Sj′+Sl′+Sn′)

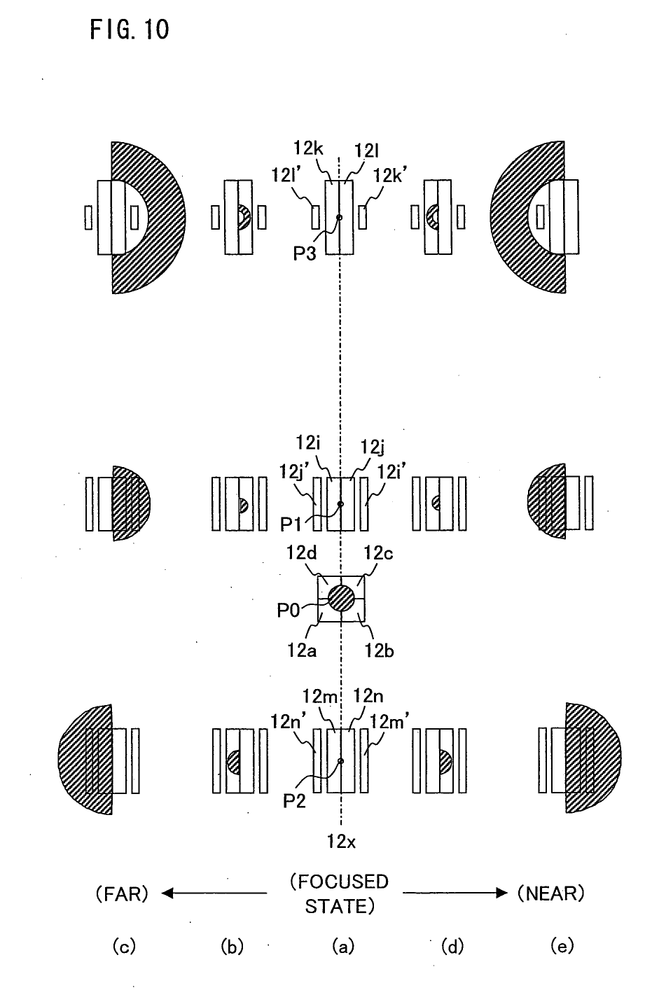

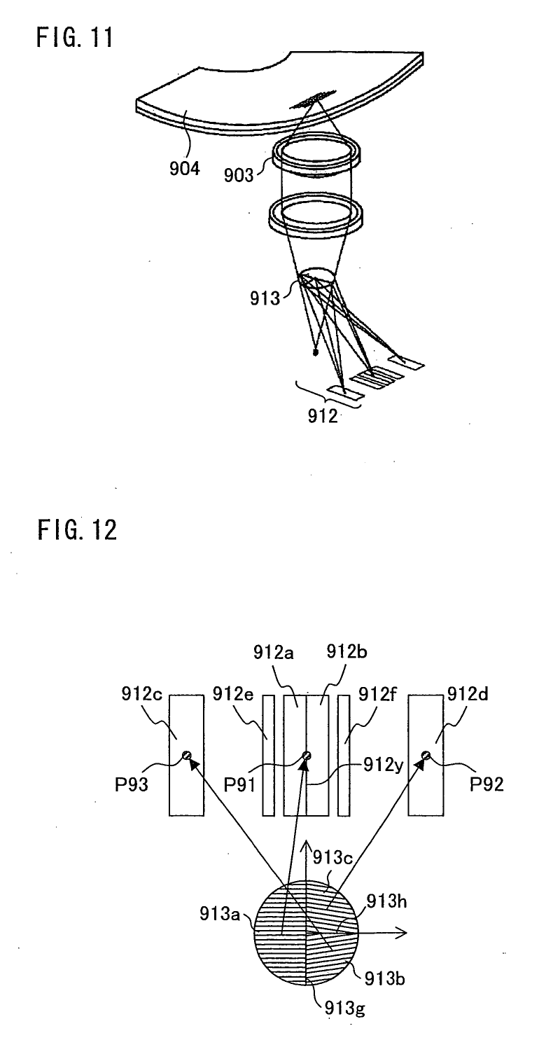

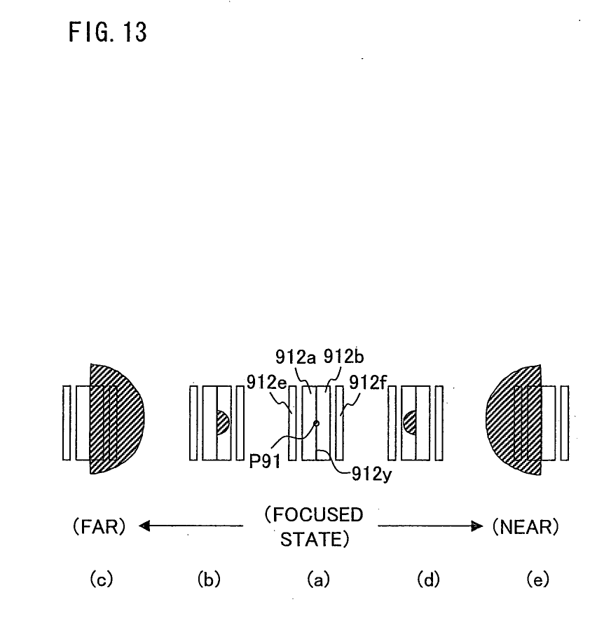

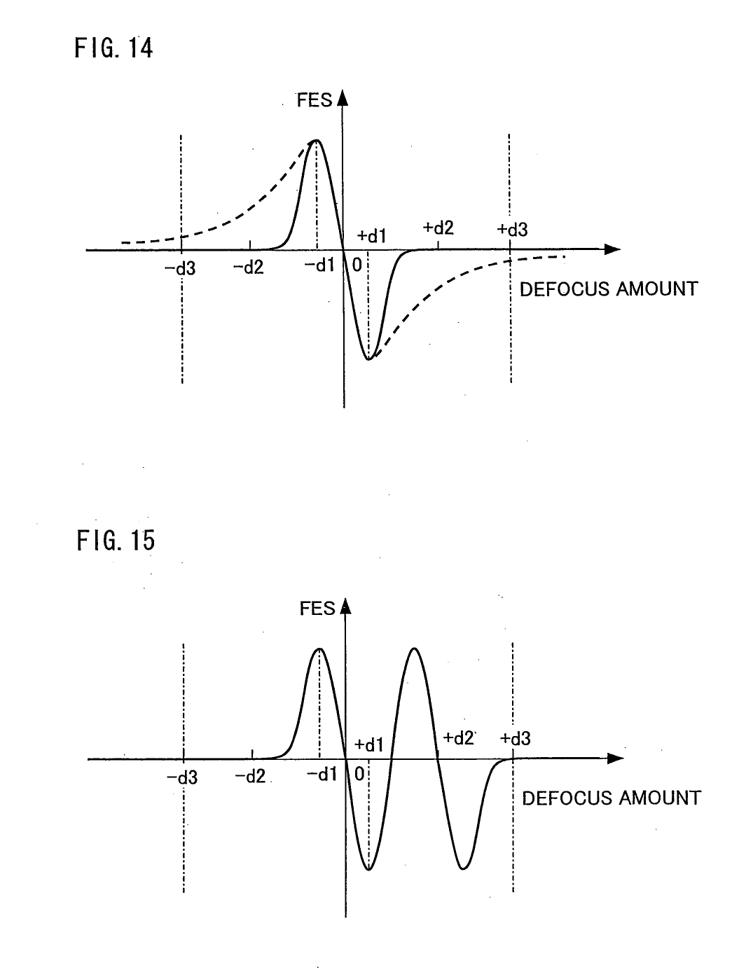

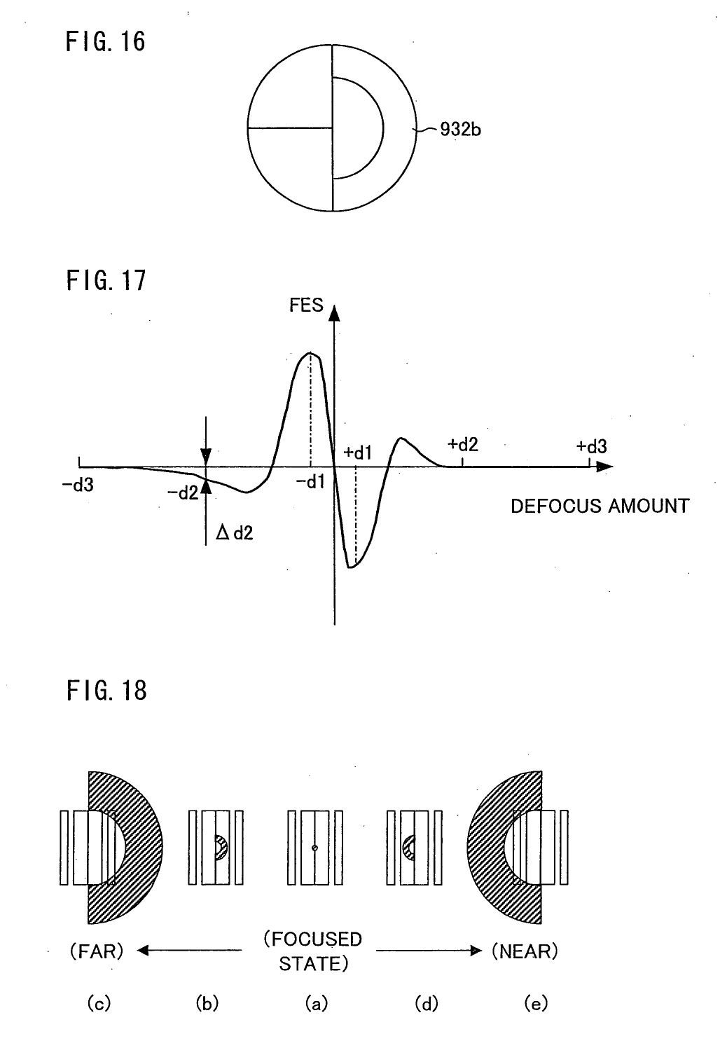

Described in detail with reference to FIG. 10 are the light receiving regions 12i, 12i′, 12j, 12j′, 12k, 12k′, 12l, 12l′, 12m, 12m′, 12n, and 12n′ and the light beams P1, P2, and P3, all of which are associated with the focus error signal FES. As illustrated in FIG. 10(a), in a focused state, the light beams P1, P2, and P3 are converged.

Also in the third embodiment, the FES is detected in accordance with the double knife-edge method. Therefore, the present embodiment is the same as the third embodiment except that both the positive and negative first-order diffracted light beams are used. For this reason, it is obvious that this prevents an offset from occurring in the FES and thereby allows for an accurate focus servo.

Furthermore, since the light beam from the region 32a and the light beam from the region 32b are used, an increase in amount of light detected in the light receiving regions is expected. It is obvious that this makes it possible to obtain a good-quality FES signal with large amplitude.

Further, since all the light beams from the hologram element are used, it is possible to obtain a good-quality FES signal with large amplitude. In addition, since the polarizing/diffracting element 15 adjusts the center of the optical axis by rotating the same, an offset in the FES detected in accordance with the double knife-edge method can be reliably adjusted.

The auxiliary light receiving regions 12i′ through 12n′ are not limited to those described in the foregoing embodiments. The auxiliary light receiving region 12i′ only needs to be positioned farther in a vertical direction from the division line 12x than the main light receiving region 12j so as to be adjacent to the main light receiving region 12j. The auxiliary light receiving region 12j′ only needs to be positioned farther in a vertical direction from the division line 12x than the main light receiving region 12i so as to be adjacent to the main light receiving region 12i. The auxiliary light receiving region 12k′ only needs to be positioned farther in a vertical direction from the division line 12x than the main light receiving region 12l so as to be adjacent to the main light receiving region 12l. The auxiliary light receiving region 12l′ only needs to be positioned farther in a vertical direction from the division line 12x than the main light receiving region 12k so as to be adjacent to the main light receiving region 12k. The auxiliary light receiving region 12m′ only needs to be positioned farther in a vertical direction from the division line 12x than the main light receiving region 12n so as to be adjacent to the main light receiving region 12n. The auxiliary light receiving region 12n′ only needs to be positioned farther in a vertical direction from the division line 12x than the main light receiving region 12m so as to be adjacent to the main light receiving region 12m. The auxiliary light receiving regions 12i′ through 12n′ only need to be shaped (in terms of width, length, etc.) and disposed so that a change occurring in an amount of light received by the main light receiving regions 12i through 12n can be compensated (cancelled).

Further, in all the foregoing configurations, the main light receiving regions 12i through 12n and the auxiliary light receiving regions 12i′ through 12n′ are shaped (in terms of width, length, etc.) and disposed so that the FES can be decreased to 0 at a desired defocus amount. That is, the main light receiving regions 12i through 12n and the auxiliary light receiving regions 12i′ through 12n′ are shaped (in terms of width, length, etc.) and disposed so that the focus error signals obtained from the main light receiving regions 12i through 12n can be corrected by the auxiliary light receiving regions 12i′ through 12n′. This allows for such a setting that FESs of a plurality of recording/reproducing layers in a mutilayer optical disk do not interfere with one another. The setting is carried out in accordance with an interval with which the recording/reproducing layers are provided.

Further, the focus error signal FES may be generated by carrying out the foregoing calculation. The foregoing calculation is carried out by amplifying or attenuating outputs from the auxiliary light receiving regions 12k′ and 12l′ at a fixed ratio with respect to the main light receiving regions 12i through 12n. This increases a degree of freedom of configuration of the auxiliary light receiving regions 12i′ through 12n′.

In the present embodiment, the positive first-order diffracted light beams are used as the light beams P1 and P3, which are diffracted by the regions 32a and 32b, respectively, of the second polarizing hologram element 32. The negative first-order diffracted light beam is used as the light beam P2, which is diffracted by the region 32c of the second polarizing hologram element 32. In contrast, the negative first-order diffracted light beams may be used as the light beams P1 and P3, and the positive first-order diffracted light beam may be used as the light beam P2. However, in order to correct a spherical aberration, diffracted light beams of the same type are preferably used as the light beams P1 and P3.

The optical pickup device of the foregoing arrangement generates a focus error signal by using at least one of the light beams generated by the first region, the second region, and the third region. Thus, no focus offset occurs even when there is stray light from another layer. Therefore, a more accurate focus control can be carried out.

Further, the optical pickup device of the foregoing arrangement may be arranged such that the focus error signal of the light beam separated by the separation means 32 is detected by using both the positive and negative first-order diffracted light beams.

This makes it possible to improve a degree of freedom of configuration of the light receiving regions and to obtain a good-quality signal in terms of signal amplitude. Further, since the polarizing/diffracting element 15 adjusts the center of the optical axis by rotating the same, an offset in the FES can be reliably adjusted.

The first to third embodiments assume that the three beams are generated by the first polarizing hologram element 31. The present invention can be applied to a one-beam optical pickup device that does not use three beams for generating a TES.

As described above, the optical pickup device according to the present invention is preferably arranged such that the auxiliary light receiving region is sized so that, in a critical state in which the main light receiving region is not irradiated with the second light beam, the auxiliary light receiving region is not irradiated with the second light beam, either.

The “critical state in which the main light receiving region is not irradiated with the second light beam” refers to a state in which the light beam stops being projected on the main light receiving region. This occurs when there is a change in size of the second light beam projected on the main and auxiliary light receiving regions. This change in size occurs because of a change in diameter of the light beam projected on the separation means. This change in diameter occurs when there is a change in state of the light reflected from the storage medium, or more specifically, when there is a change in diameter of the light beam reflected from the storage medium. That is, the critical state refers to a point of time at which, due to the change in diameter of the light beam reflected from the storage medium, the light beam is no longer projected on the main light receiving region.

According to the foregoing arrangement, the auxiliary light receiving regions are sized so that, when the main light receiving regions are not irradiated with the second light beam, the auxiliary light receiving regions are not irradiated with the second light beam, either. Thus, the return light from the non-recording layer is projected on a larger area of each of the light receiving sections than the return light from the recording layer. Therefore, the foregoing arrangement makes it possible to more reliably prevent such a problem that, although the return light from the non-recording signal is not projected on the main light receiving regions, the return light from the non-recording layer is projected only on the auxiliary light receiving regions.

The optical pickup device according to the present invention further includes a first light receiving section for receiving the first light beam, the first light receiving section including (i) at least two first main light receiving regions, which are provided with a first division line therebetween parallel to the division line so as to be adjacent to each other, and (ii) one of more first auxiliary light receiving regions, which receive a portion of the first light beam which portion protrudes from each of the first main light receiving regions, the auxiliary light receiving region detecting only the second light beam, and each of the first auxiliary light receiving regions detecting only the first light beam.

According to the foregoing arrangement, the first auxiliary light receiving region and the auxiliary light receiving region receive only the first light beam and the second light beam, respectively. This makes it possible to prevent the first light beam from entering the auxiliary light receiving region for receiving the second light beam and to prevent the second light beam from entering the auxiliary light receiving region for receiving the first light beam, even when the first and second light beams are in their defocused states. Thus, no offset occurs in a focus signal. Therefore, accurate focus control can be carried out.

Further, the optical pickup device according to the present invention is preferably arranged such that: the first main light receiving region is as long as the first auxiliary light receiving regions in the drawing direction of the division line, and the auxiliary light receiving region is shorter than the first auxiliary light receiving region in the drawing direction of the division line.

The first light beam includes the optical axis of the light beam reflected from the storage medium, and when the first light beam is projected on the light receiving section, the first light beam is projected, for example, in its semicircular shape. Therefore, even when the light beam is not focused, the first light beam is never projected only on the first auxiliary light receiving regions without being projected on the first main light receiving regions. Further, the light receiving regions having larger light receiving areas can detect a larger quantity of light beams than when the light receiving regions have smaller areas. Therefore, the first light beam can be more accurately detected by using the foregoing arrangement in which the first main light receiving regions are of the same length as the first auxiliary light receiving regions in the drawing direction of the division line. Further, by causing the auxiliary light receiving regions to be shorter than the first auxiliary light receiving regions, it is possible to prevent such a problem that, although the return light from the non-recording layer is not projected on the main light receiving regions, the return light is projected on the auxiliary light receiving regions.

Furthermore, the optical pickup device according to the present invention is preferably arranged such that the auxiliary light receiving regions are symmetrical about the division line.

According to the foregoing arrangement, the auxiliary light receiving regions are provided on opposing sides of the division line. Thus, even if a multilayer storage medium is adopted, it is possible to prevent a focus offset from occurring in both (i) stray light from a layer closer to a recording layer (reproducing layer), and (ii) stray light from a layer far from a recording layer. Therefore, accurate focus control can be carried out.

Further, the optical pickup device according to the present invention is preferably includes calculation means for generating a focus error signal by obtaining a difference between a first signal and a second signal, the first signal being obtained by adding (i) an output signal from the main light receiving region provided on a first side in the direction orthogonal to the division line and (ii) an output signal from the auxiliary light receiving region provided on a second side in the direction orthogonal to the division line opposite to the first side, the second signal being obtained by adding (I) an output signal from the main light receiving region provided on the second side and (II) an output signal from the auxiliary light receiving region provided on the first side.

The foregoing arrangement prevents a focus offset from occurring even when there is stray light from a non-recording layer, and thereby allows for accurate focus control.

Furthermore, the optical pickup device according to the present invention is preferably arranged such that: the separation means is a hologram element that separates the light beam by diffracting the light beam, the light beam passing through the converging means, and the hologram element separates the light beam into portions corresponding respectively to at least two regions provided with a straight line therebetween substantially parallel to a diffraction direction of the light beam, and the focus error signal is generated in accordance with the light beam diffracted in either one of the at least two regions divided by the straight line.

According to the foregoing arrangement, the focus error signal is generated in accordance with the light beam diffracted in either one of the regions divided by the straight line substantially parallel to the diffraction direction of the hologram element. This prevents a focus offset from occurring even when there is stray light from a non-recording layer, and thereby allows for accurate focus control. Note that a direction substantially parallel to the diffraction direction of the hologram element refers to a direction orthogonal to the track direction.

Further, the optical pickup device according to the present invention preferably detects a spherical aberration in accordance with a signal representing a difference between (i) an output signal obtained from the first light beam, and (ii) an output signal obtained from the second light beam.

According to the foregoing arrangement, the differential signal is detected from the respective output signals obtained from the first light, which includes the optical axis of the light beam reflected from the storage medium, and the second light, which surrounds the curved side of the first light beam, and the spherical aberration is detected in accordance with the differential signal. Thus, a good-quality recording/reproducing signal can be obtained with respect to any one of a plurality of recording layers of a mutilayer optical storage medium wherein the plurality of recording layers are provided with cover layers that are different in terms of thickness.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An optical pick up device, comprising:
separation means for separating a light beam, which is reflected from a storage medium and then passes through converging means, into (i) a first light beam, which includes an optical axis of the light beam, and (ii) a second light beam, which surrounds a curved side of the first light beam; and
a second light receiving section for receiving the second light beam,
the second light receiving section including (I) at least two main light receiving regions, which are provided with a division line therebetween so as to be adjacent to each other, and (II) one or more auxiliary light receiving regions, which receive a portion of the second light beam which portion protrudes from each of the main light receiving regions,
each of the auxiliary light receiving regions being positioned in a direction orthogonal to a drawing direction of the division line so as to be adjacent to the main light receiving region,
the auxiliary light receiving region being shorter than the main light receiving region in the drawing direction of the division line.

2. The optical pickup device as set forth in claim 1, wherein the auxiliary light receiving region is sized so that, in a critical state in which the main light receiving region is not irradiated with the second light beam, the auxiliary light receiving region is not irradiated with the second light beam, either.

3. The optical pickup device as set forth in claim 1, further comprising a first light receiving section for receiving the first light beam,
the first light receiving section including (i) at least two first main light receiving regions, which are provided with a first division line therebetween parallel to the division line so as to be adjacent to each other, and (ii) one or more first auxiliary light receiving regions, which receive a portion of the first light beam which portion protrudes from each of the first main light receiving regions,
the auxiliary light receiving region detecting only the second light beam, and
each of the first auxiliary light receiving regions detecting only the first light beam.

4. The optical pickup device as set forth in claim 1, wherein:
the first main light receiving region is as long as the first auxiliary light receiving region in the drawing direction of the division line, and
the auxiliary light receiving region is shorter than the first auxiliary light receiving region in the drawing direction of the division line.

5. The optical pickup device as set forth in claim 1, wherein the auxiliary light receiving regions are symmetrical about the division line.

6. The optical pickup device as set forth in claim 1, further comprising calculation means for generating a focus error signal by obtaining a difference between a first signal and a second signal, the first signal being obtained by adding (i) an output signal from the main light receiving region provided on a first side in the direction orthogonal to the division line and (ii) an output signal from the auxiliary light receiving region provided on a second side in the direction orthogonal to the division line opposite to the first side, the second signal being obtained by adding (I) an output signal from the main light receiving region provided on the second side and (II) an output signal from the auxiliary light receiving region provided on the first side.

7. The optical pickup device as set forth in claim 1, wherein:
the separation means is a hologram element that separates the light beam by diffracting the light beam, the light beam passing through the converging means,
the hologram element separates the light beam into portions corresponding respectively to at least two regions provided with a straight line therebetween substantially parallel to a diffraction direction of the light beam, and
the focus error signal is generated in accordance with the light beam diffracted in either one of said at least two regions divided by the straight line.

8. The optical pickup device as set forth in claim 1, which detects a spherical aberration in accordance with a signal representing a difference between (i) an output signal obtained from the first light beam, and (ii) an output signal obtained from the second light beam.
